(19) United States
(12) Patent Application Publication
(10) Pub. No.: US 2007/0125383 A1
(43) Pub. Date: Jun. 7, 2007

(54) Facial mask

(76) Inventor: Chuan Tao Ko, Fongyuan City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/293,745

(22) Filed: Dec. 2, 2005

(51) Int. Cl. A62B 23/02; A62B 18/02; A62B 18/08

(52) U.S. Cl. 128/206.21; 128/206.12

(57) ABSTRACT

A facial mask includes a permeable sheet and a nanometer metal layer coated on a side of the permeable sheet. The permeable sheet is made of adhesive-bonded fabric and is formed with a nose portion, three openings corresponding to eyes and mouth, and multiple split lines. The nanometer metal layer is composed of nanometer gold particles or nanometer sliver particles. A skin care substance layer is coated on the at least one nanometer metal layer. It is very easy and convenient to clean the facial mask, so the facial mask can be used repeatedly.

### BACKGROUND OF THE INVENTION

1. Field of the Invention

The present invention relates to a skin care product, and more particularly to a facial mask which can be easily cleaned for being used repeatedly.

2. Description of Related Art

As a common skin care product, a facial mask is a thin sheet made of adhesive-bonded fabric. The facial mask can be made with various shapes to correspond a whole face or a part of the face such as nose, eyes, chin, cheek etc. The adhesive-bonded fabric sheet is applied with skin care components such as lotion, essence or cream etc. When a user covers the facial mask on the user's face, the skin care components will be absorbed in skin of the user's face.

Because the facial mask will absorb dirt on the user's face during releasing skin care component, the used facial mask is dirty. These dirt are deeply penetrated into fibers of the adhesive-bonded fabric. It is very difficult to completely clean the facial mask, so the used facial mask will be directly abandoned and can not be used repeatedly.

Therefore, the invention provides a facial mask to mitigate or obviate the aforementioned problems.

### SUMMARY OF THE INVENTION

The main objective of the present invention is to provide a facial mask which can be easily cleaned for being used repeatedly.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a facial mask in accordance with the present invention;

FIG. 2 is a cross sectional view of a first embodiment of the present invention; and

FIG. 3 is a cross sectional view of a second embodiment of the present invention.

### DETAILED DESCRIPTION OF THE PREFERRED EMBODIMENTS

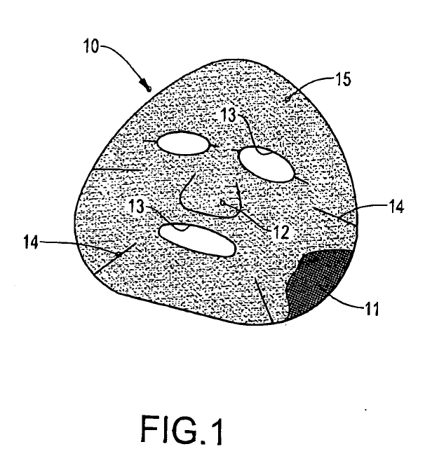

With reference to FIG. 1, a facial sheet in accordance with the present invention includes a body (10). In this embodiment, the body (10) is formed as a shape to correspond a whole face. Of course, the body (10) also can be formed as a part of a face.

The body (10) includes a permeable thin sheet (11) made of adhesive-bonded fabric. The permeable thin sheet (11) has a nose portion (12), three openings (13) corresponding to eyes and mouth, and multiple split lines (14) for the facial mask being tightly pasted on a face of a user.

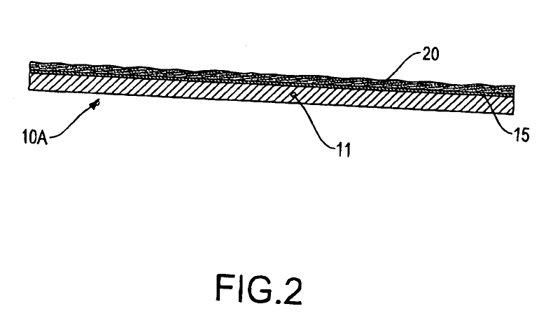

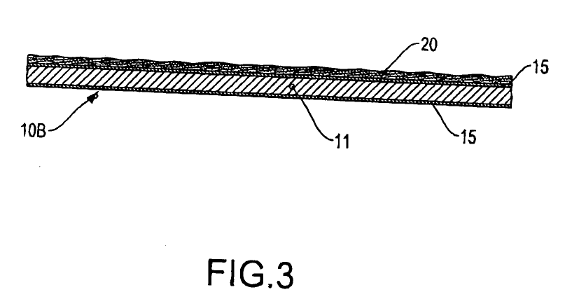

With reference to FIG. 2, one side of the permeable thin sheet (11) is coated with a nanometer metal layer (15). The nanometer metal layer (15) is composed of nanometer gold particles or nanometer sliver particles. In another embodiment as illustrated in FIG. 3, both sides of the permeable thin sheet (11) are coated with a nanometer metal layer (15). A skin care substance layer (20) is coated on the nanometer metal layer (15). The skin care substance layer (20) can include lotion, essence or cream.

In another embodiment, the facial mask excludes the skin care substance layer (20), and tie skin care substance layer (20) is coated on the nanometer metal layer (15) by die user on demand.

When the user covers the facial mask on the user's face, the nanometer gold or sliver particles with a diameter about 10-20 nm have high activity and can easily penetrate into the user's skin along with the effective components of the skin care substance layer (20).

After using, the dirt on the user's face and remaindering skin care substance cling on the nanometer metal layer (15) and will not penetrate into fibers of the permeable thin sheet (11). It is very easy and convenient to clean the facial mask for repeatedly using the facial mask. Therefore, because the facial mask can be repeatedly used, the using cost is low and it is advantageous to protect environment.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A facial mask comprising:
a permeable sheet; and
at least one nanometer metal layer coated on at least one side of the permeable sheet.

2. The facial mask as claimed in claim 1, wherein two nanometer metal layers are respectively coated on both sides of the permeable sheet.

3. The facial mask as claimed in claim 1, wherein the nanometer metal layer is composed of nanometer gold particles.

4. The facial mask as claimed in claim 1, wherein the nanometer metal layer is composed of nanometer sliver particles.

5. The facial mask as claimed in claim 1, wherein the permeable sheet is made of adhesive-bonded fabric.

6. The facial mask as claimed in claim 5, wherein the permeable sheet is formed with a nose portion, three openings adapted for corresponding to eyes and mouth of a user, and multiple split lines.

7. The facial mask as claimed in claim 1 further comprising a skin care substance layer coated on the at least one nanometer metal layer.

8. The facial mask as claimed in claim 2 further comprising a skin care substance layer coated on one of the nanometer metal layers.
